(19) United States
(12) Patent Application Publication
(10) Pub. No.: US 2006/0139727 A1
(43) Pub. Date: Jun. 29, 2006

(54) Hybrid fiber polarization dependent isolator, and laser module incorporating the same

(76) Inventors: Rachid Gafsi, Corning, NY (US); James E. Hollis, Horseheads, NY (US); Daniel Aloysius Nolan, Corning, NY (US); George Francis Wildeman, Painted Post, NY (US)

Correspondence Address: CORNING INCORPORATED, SP-TI-3-1, CORNING, NY, 14831, US

(21) Appl. No.: 11/073,316

(22) Filed: Mar. 4, 2005

Related U.S. Application Data
(60) Provisional application No. 60/639,707, filed on Dec. 28, 2004.

(51) Int. Cl. G02F 1/09

(52) U.S. Cl. 359/280

(57) ABSTRACT

A polarization dependent isolator includes a Faraday element, a linear polarizer positioned at a first end of the Faraday element to polarize light entering the first end of the Faraday element, and a single polarization fiber positioned at a second end of the Faraday element to receive light emerging from the second end of the Faraday element. A laser module includes a semiconductor laser diode, a Faraday element positioned adjacent the semiconductor laser diode, a linear polarizer positioned at a first end of the Faraday element nearest to the semiconductor laser diode to polarizer light passing from the laser diode to the first end of the Faraday element, and a single polarization fiber positioned at a second end of the Faraday element furthest from the semiconductor laser diode to receive light emerging from the second end of the Faraday element, wherein the single polarization fiber also serves as coupling output fiber for the laser module.

### FIELD OF THE INVENTION

The invention relates generally to optical isolators and specifically to design and assembly of polarization dependent isolators. This application claims priority to Provisional Application No. 60/639,707, filed on Dec. 28, 2004, entitled HYBIRD FIBER POLARIZATION DEPENDENT ISOLATOR, AND LASER MODULE INCORPOATING THE SAME.

### BACKGROUND OF THE INVENTION

Optical transmitter and transponder systems use polarization dependent isolators (PDIs) to immunize lasers from return beams since such return beams are known to destabilize oscillation of lasers.

FIG. 1 shows a typical single stage PDI 100. For high optical isolation, two or more of the single stage PDI 100 can be cascaded in series. The PDI 100 includes a Faraday element 102, typically made of Yttrium-Iron-Garnet (YIG) or Terbium-Gallium-Garnet (TGG). The Faraday element 102 is positioned between an input polarizer 104 and an output polarizer (also known as analyzer) 106. The polarization axis of the output polarizer 106 is set at 45° relative to the polarization axis of the input polarizer 104. A permanent magnet 108, typically made of a rare-earth metal, applies a magnetic field to the Faraday element 102, making the Faraday element 102 optically active. The direction of the magnetic field is represented by arrow 108a.

Input beam 110, moving in the forward direction, is linearly polarized in the input polarizer 104. The linearly polarized beam passes through the Faraday element 102, where the magnetic field applied by the permanent magnet 108 acts in concert with the Faraday element 102 to rotate the polarization plane of the beam by 45°, allowing the beam to then pass through the output polarizer 106, as indicated at 112. Any return beam is first polarized at 45° by the output polarizer 106. Since the Faraday effect is non-reciprocal, the return beam is rotated an additional 45° upon passing through the Faraday element 102, and then blocked by the input polarizer 104.

The polarizers 104, 106 are typically polarizing glass plates, polarizing prisms, and the like. To ensure desired characteristics of the PDI 100, the polarizers 104, 106 must be accurately aligned in a plane perpendicular to an optical axis of the Faraday element 102 and the appropriate angle, in this case 45°, must be formed between the polarizers 104, 106. Once the polarizers 104, 106 are aligned with the Faraday element 102, the PDI components are individually fixed in place using techniques such as soldering, gluing, or welding. To maintain the appropriate angle between the polarizers 104, 106, fixing of the PDI components in place must be highly precise. This makes assembly of the PDI somewhat labor intensive.

Various solutions have been proposed to make it easier to assemble a PDI. For example, U.S. Pat. No. 5,757,538 (Siroki et al.) proposes forming wire grid polarizers, i.e., unidirectional gratings of thin silver films, on opposite surfaces of a garnet film at the appropriate angle and working the garnet film into a chip that then serves as a Faraday element. This avoids the need to individually fix the polarizers and Faraday element in place. The Faraday element is placed within a permanent magnet and used as a PDI. U.S. Pat. No. 6,813,077 (Borrelli et al.) discloses a method of forming wire grid polarizers on a garnet material and a wire grid structure that suppresses reflection of rejected polarization.

In addition to finding easier ways to assemble the PDI, it is also desirable to miniaturize the PDI, thereby allowing a laser module incorporating the PDI to be made small.

### SUMMARY OF THE INVENTION

In one aspect, the invention relates to a PDI which comprises a Faraday element, an input polarizer positioned at an input end of the Faraday element to polarize an input beam entering the input end of the Faraday element, and a single polarization fiber positioned at an output end of the Faraday element to receive an output beam emerging from the output end of the Faraday element.

In another aspect, the invention relates to a polarization dependent isolator which comprises a first isolator unit, a second isolator unit cascaded in series with the first isolator unit, and a single polarization fiber positioned adjacent the second isolator unit to receive a beam emerging from the second isolator unit, wherein each of the isolator units comprises an input polarizer positioned at an input end of a Faraday element to polarize an input beam entering the input end of the Faraday element.

In yet another aspect, the invention relates to a laser module which comprises a laser diode, a Faraday element positioned adjacent the laser diode, an input polarizer positioned at an input end of the Faraday element nearest to the laser diode to polarize light passing from the laser diode to the input end of the Faraday element, and a single polarization fiber positioned at an output end of the Faraday element furthest from the laser diode to receive light emerging from the output end of the Faraday element, wherein the single polarization fiber also serves as coupling output fiber for the laser module.

Other features and advantages of the invention will be apparent from the following description and the appended claims.

### BRIEF DESCRIPTION OF THE DRAWINGS

FIG. 1 is a schematic of a prior art PDI.

FIG. 2A is a schematic of a single stage PDI according to one embodiment of the invention.

FIG. 2B is a schematic of a single stage PDI according to one embodiment of the invention.

FIG. 3 is a cross-section of a single polarization fiber.

FIG. 4 shows typical cutoff wavelengths for two polarization modes of a single polarization fiber designed to operate at a nominal wavelength of 1550 nm.

FIGS. 5A and 5B are schematics of laser modules incorporating a PDI according to one embodiment of the invention.

FIG. 6A is a schematic of a double stage PDI according to one embodiment of the invention.

FIG. 6B is a schematic of a double stage PDI according to another embodiment of the invention.

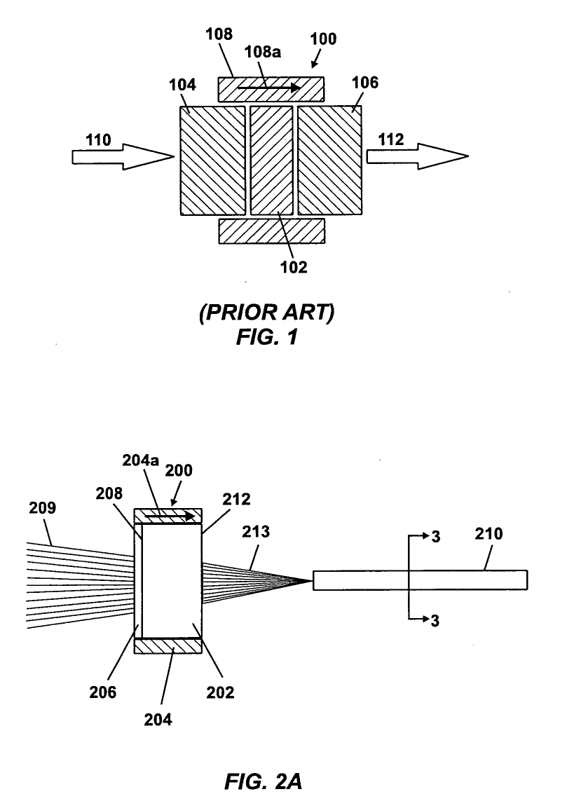

### DETAILED DESCRIPTION OF THE INVENTION

The invention will now be described in detail with reference to a few preferred embodiments, as illustrated in accompanying drawings. In the following description, numerous specific details are set forth in order to provide a thorough understanding of the invention. However, it will be apparent to one skilled in the art that the invention may be practiced without some or all of these specific details. In other instances, well-known features and/or process steps have not been described in detail in order to not unnecessarily obscure the invention. The features and advantages of the invention may be better understood with reference to the drawings and discussions that follow.

Embodiments of the invention provide a polarization dependent isolator (PDI) which has fewer number of assembly steps in comparison to conventional PDIs. The PDI enables a laser module to be produced with fewer components. In particular, the PDI uses a single polarization fiber instead of the conventional analyzer or output polarizer. When the PDI is incorporated in a laser module, the single polarization fiber doubles up as the coupling output fiber of the laser module. In one embodiment, the PDI has an insertion loss ≦0.5 dB. In one embodiment, the PDI has an isolation ≧40 dB. PDIs according to embodiments of the invention may be designed to operate at nominal wavelengths in a range from 800 to 1900 nm. PDIs of the invention may be cascaded in series for high optical isolation applications.

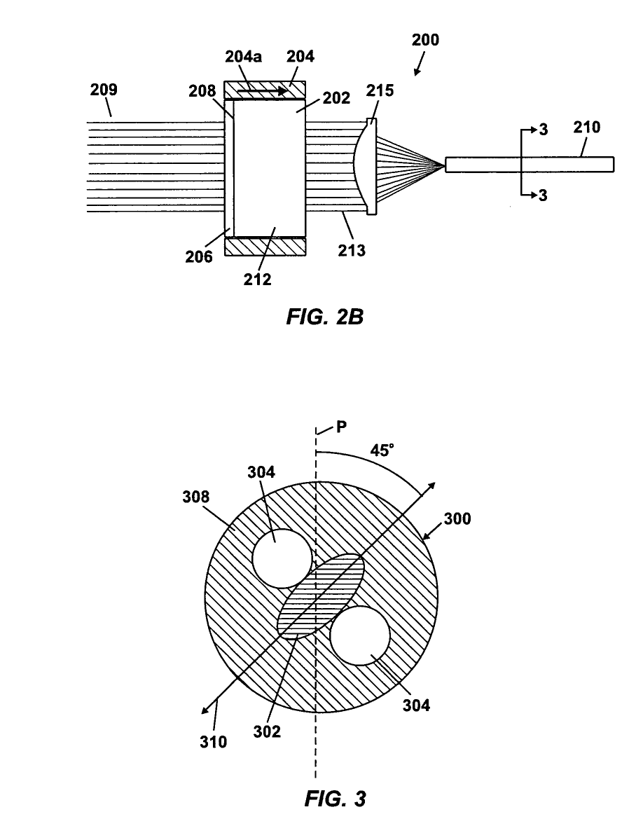

FIG. 2A illustrates a single stage PDI 200 according to one embodiment of the invention. The PDI 200 includes a Faraday element 202 made of a magneto-optical garnet, such as rare-earth iron garnet, e.g., yttrium iron garnet (YIG), bismuth-substituted iron garnet, e.g., bismuth-substituted yttrium iron garnet, and rare-earth gallium garnet, e.g., terbium gallium garnet (TGG). YIG is typically used at wavelengths in a range from 1100 to 2100 nm. TGG is typically used at wavelengths in a range from 500 to 1100 nm. The Faraday element 202 can be of the latching or non-latching type. In the illustration, the Faraday element 202 is of the non-latching type and is disposed within a permanent magnet 204. A Faraday element of the latching type may be operated without a bias magnet. Typically, the permanent magnet 204 is a rare-earth magnet, e.g., Sm—Co type rare-earth magnet. The permanent magnet 204 applies a magnetic field to the Faraday element 202, allowing the Faraday element 202 to become optically active. When a polarized light passes through the Faraday element 202 in a direction 204a of the magnetic field, the polarization plane of the light is rotated. The amount of rotation depends on the field strength and the distance the light travels through the Faraday element 202. In one embodiment, the permanent magnet 204 and the Faraday element 202 are designed such that the polarization plane of a polarized light passing through the Faraday element 202 is rotated by approximately 45°.

An input polarizer 206 is formed on an input end 208 of the Faraday element 202. In one embodiment, the input polarizer 206 is a linear polarizer. In one embodiment, the polarization axis of the input polarizer 206 is at 0° relative to the polarization axis of the input beam 209. That is, the polarization axis of the input beam 209 and the polarization axis of the input polarizer 206 are aligned to a maximum transmission. The polarization axis is referred to as the direction of the electric-field vector \vec{E}(r,t), where r is the radial distance in spherical coordinates (in meter) and t is the time (in seconds). The input polarizer 206 may be a dichroic polarizer, such as one sold under the trade name Polarcor® glass polarizer. Alternatively, the input polarizer 206 may be a wire grid polarizer. The wire grid polarizer may be formed directly on the input end 208 of the Faraday element 202. U.S. Pat. No. 6,813,077 (Borrelli et al.) describes a method of forming a wire grid polarizer directly on a garnet material. In a forward direction, the input polarizer 206 polarizes the input beam 209 prior to the input beam entering the Faraday element 202.

A single polarization fiber 210 is positioned adjacent an output end 212 of the Faraday element 202. The single polarization fiber 210 is positioned to receive beam 213 emerging from the Faraday element 202. Where the input beam 209 is collimated, a focusing lens (215 in FIG. 2B) is preferably inserted between the Faraday element 202 and the single polarization fiber 210 to focus beam 213 into the single polarization fiber 210. The single polarization fiber 210 propagates only one of two orthogonally polarized polarizations while suppressing the other polarization by increasing its transmission loss. The polarization axis of the single polarization fiber 210 is set at 45° relative to the polarization axis of the input polarizer 206. In comparison to the conventional PDI, the single polarization fiber 210 replaces the output polarizer or analyzer. When the PDI 200 is incorporated in a laser module, the single polarization fiber 210 doubles up as the coupling output fiber, thereby reducing the number of components in the laser module.

Any suitable single polarization fiber may be used in the invention. A suitable example of a single polarization fiber is described in U.S. application Ser. No. 10/864,732, the disclosure of which is incorporated herein by reference. FIG. 3 shows a cross-section 300 of the single polarization fiber disclosed in U.S. application Ser. No. 10/864,732. The cross-section 300 shows an elongated core 302 with two air holes 304, 306 placed next to the core 302. In one embodiment, the elongated core 302 is elliptical and the air holes 304, 306 are placed along the minor axis of the ellipse. The aspect ratio of the core 302 is typically between 1.5 and 8, preferably greater than 1.5, more preferably between 2 and 5. The air holes 304, 306 and core 304 are surrounded by cladding 308. The cladding 308 has a higher refractive index than the core 304. The core 304 may be made of germania-doped silica, and the cladding 308 may be made of fluorine-doped silica. The polarization axis 310 is shown at 45° relative to the polarization axis P of the input polarizer (206 in FIGS. 2A and 2B).

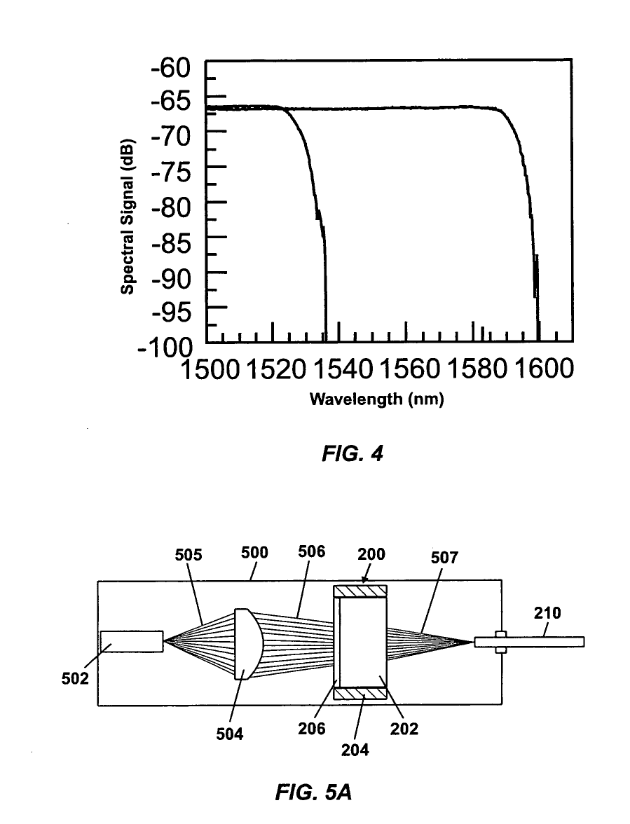

For a single polarization fiber having the cross-section 310, the air holes 304, 306 create differential cutoff wavelengths for the two polarization modes, i.e., the attenuated and the transmitted modes. This differential cutoff makes single polarization propagation possible. FIG. 4 shows typical cutoff wavelengths for the two polarization modes of a single polarization fiber designed for a nominal wavelength of 1550 nm. The polarization bandwidth is around 60 nm. The polarization bandwidth is the difference in wavelength measured as >5 dB of loss on the attenuated polarization and <1 dB of loss on the transmitted polarization. The polarization bandwidth can be tuned by changing the fiber parameters. Single polarization fibers having polarization bandwidth in a range from 18 to 100 nm are useful in the invention.

A laser module incorporating a PDI of the invention is suitable for use in optical transmission and transponder systems, such as DWDM (Dense Wavelength Division Multiplexing), SONET/SDH (Synchronous Optical NETwork/Synchronous Digital Hierarchy, and ATM (Asynchronous Transfer Mode) systems. Also, it could be used in fiber optic sensors (such as fiber optic gyroscopes and current sensors), in optical interferometers and measurements systems.

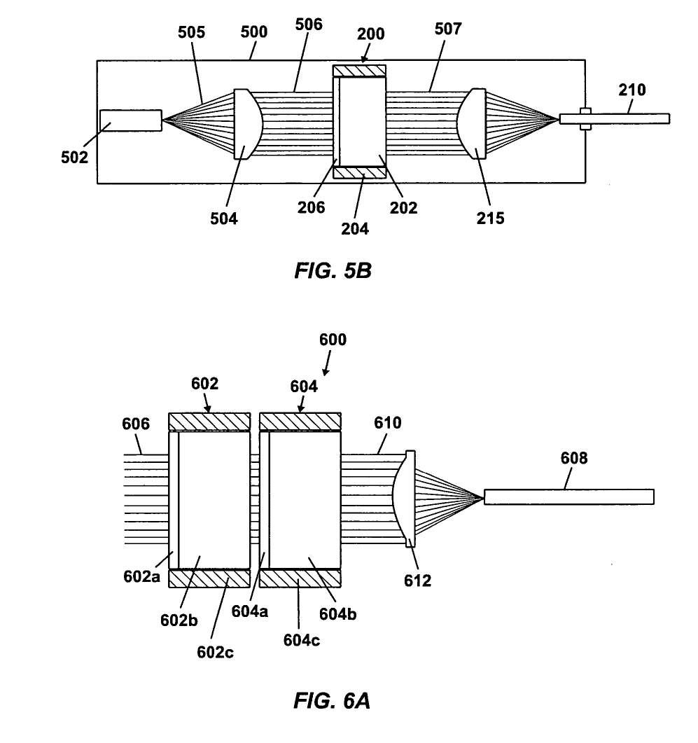

FIG. 5A illustrates a laser module 500 incorporating the PDI 200 (also shown in FIG. 2A). The laser module 500 includes a laser diode 502, e.g., a distributed feedback (DFB) laser or a Fabry-Pérot laser. The laser module 500 includes a lens 504 which focuses a beam 505 generated by the laser 502 on the input polarizer 206 of the PDI 200. The focused beam 506 passes through the input polarizer 206, where it is linearly polarized, and then through the Faraday element 202, where it is rotated 45°. The beam 507 emerging from the Faraday element 202 is coupled into the single polarization fiber 210 of the PDI 200. In an alternate embodiment, as shown in FIG. 5B, the beam 506 entering the input polarizer 206 is a collimated beam, and the lens 215 (also shown in FIG. 2B) improves coupling efficiency between the Faraday element 202 and the single polarization fiber 210 by focusing the beam 507 emerging from the Faraday element 202 into the single polarization fiber 210. In either of the embodiments illustrated in FIGS. 5A and 5B, any return beam from the single polarization fiber 210 is rotated an additional 45° by the Faraday element 202 and prevented from reaching the laser 502 by the input polarizer 206.

Returning to FIGS. 2A and 2B, the performance of the PDI 200 can be optimized by adjusting the linear and angular position of the single polarization fiber 210 relative to the Faraday element 202 such that insertion loss is minimized and isolation is maximized. In one embodiment, the PDI has an insertion loss ≦0.5 dB. In one embodiment, the PDI has an isolation ≧40 dB. PDIs according to embodiments of the invention having isolation ≧40 dB for nominal wavelengths of 1310 nm and 1550 nm have been designed. Using the appropriate and optimized materials and components (polarizers, Faraday elements, and single polarization fibers), PDIs according to embodiments of the invention having isolation ≧40 dB for nominal wavelengths other than 1310 and 1510 nm, generally, in a range from 800 nm to 1900 nm, can also be designed. PDIs according to embodiments of the invention can be cascaded in series for high optical isolation. Examples of double stage PDIs according to embodiments of the invention will now be described.

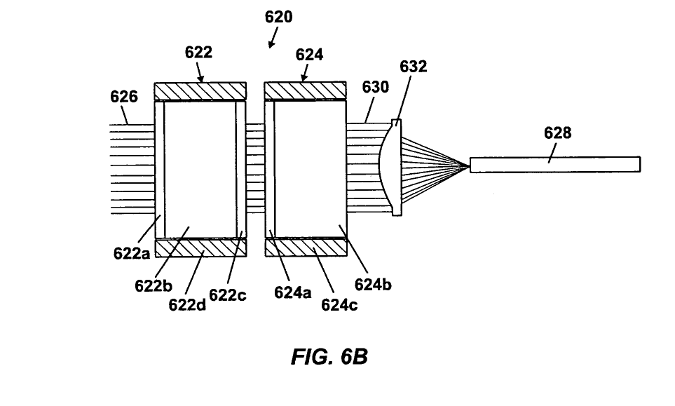

FIG. 6A shows a double stage PDI 600 according to one embodiment of the invention. The PDI 600 includes two half-isolator units 602, 604. The isolator unit 602 includes an input polarizer 602a, a Faraday element 602b, and a permanent magnet 602c (which may be omitted if the Faraday element 602b is of the latching type). The isolator unit 604 includes an input polarizer 604a, a Faraday element 604b, and a permanent magnet 604c (which may be omitted if the Faraday element 604b is of the latching type). A single polarization fiber 608 is positioned adjacent the isolator unit 604 to receive beam 610 emerging from the Faraday element 604b. When the input beam 606 is a collimated beam, a focusing lens 612 is preferably inserted between the Faraday element 604b and the single polarization fiber 608 to focus the beam 610 into the single polarization fiber 608.

In one embodiment, the polarization axis of the input polarizer 602a is at 0° relative to the polarization axis of the input beam 606, the polarization axis of the input polarizer 604a is at 45° relative to the polarization axis of the input polarizer 602a, and the polarization axis of the single polarization fiber 608 is at 90° relative to the polarization axis of the input polarizer 602a. In the forward direction, the input beam 606 passes through the input polarizer 602a, where it is linearly polarized at 0°, and then through the Faraday element 602b, where it is rotated 45°, and then through the input polarizer 604a, where it is linearly polarized at 45°, and then through the Faraday element 604b, where it is rotated an additional 45° so that it can be coupled into the single polarization fiber 608. Any return beam from the single polarization fiber 608 is rotated an additional 45° by the Faraday element 604b and then blocked by the input polarizer 604a. Any return beam escaping the input polarizer 604a (i.e., any return beam at 45° after rotation by the Faraday element 604b) is rotated an additional 45° by the Faraday element 602b and then blocked by the input polarizer 602a.

FIG. 6B shows a double-stage PDI 620 according to another embodiment of the invention. The PDI 620 includes a full-isolator unit 622 and a half-isolator unit 624. The full isolator unit 622 includes an input polarizer 622a, a Faraday element 622b, an output polarizer 622c, and a permanent magnet 622d (which may be omitted if the Faraday element 622b is of the latching type). The input polarizer 622a and output polarizer 622c are formed on opposite sides of the Faraday element 622b. In one embodiment, the polarization axis of the output polarizer 622c is at 45° relative to the polarization axis of the input polarizer 622a, and the polarization axis of the input polarizer 622a is at 0° relative to the polarization axis of the input beam 626. The half-isolator unit 624 includes an input polarizer 624a, a Faraday element 624b, and a permanent magnet 624c (which may be omitted if the Faraday element 624b is of the latching type). The input polarizer 624a is in opposing relation to the output polarizer 622c, and the polarization axis of the input polarizer 624a is aligned with the polarization axis of the output polarizer 622c.

The PDI 620 also includes a single polarization fiber 628 positioned adjacent the half-isolator unit 624 to receive beam 630 emerging from the Faraday element 624b. Where the input beam 626 is a collimated beam, a focusing lens 632 is preferably inserted between the Faraday element 624b and the single polarization fiber 628 to focus the beam 630 into the single polarization fiber 628. In one embodiment, the polarization axis of the single polarization fiber 628 is at 90° relative to the polarization axis of the input polarizer 622a, and the PDI 620 operates similarly to the PDI (600 in FIG. 6A) described above.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A polarization dependent isolator, comprising:
a Faraday element;
an input polarizer positioned at an input end of the Faraday element to polarize an input beam entering the input end of the Faraday element; and
a single polarization fiber positioned at an output end of the Faraday element to receive an output beam emerging from the output end of the Faraday element.

2. The polarization dependent isolator of claim 1, wherein the input polarizer is a linear polarizer.

3. The polarization dependent isolator of claim 1, wherein the polarization axis of the input polarizer is at approximately 0° relative to the polarization axis of the input beam.

4. The polarization dependent isolator of claim 3, wherein the polarization axis of the single polarization fiber is at approximately 45° relative to the polarization axis of the input polarizer.

5. The polarization dependent isolator of claim 4, wherein the Faraday element rotates a polarization plane of the input beam by approximately 45°.

6. The polarization dependent isolator of claim 1, wherein the single polarization fiber propagates only a single polarization mode within an operating wavelength range.

7. The polarization dependent isolator of claim 6, wherein the single polarization fiber comprises a central core and at least two air holes on opposite sides of the core.

8. The polarization dependent isolator of claim 7, wherein the central core is elliptical.

9. The polarization dependent isolator of claim 1, further comprising a magnet for applying a magnetic field to the Faraday element.

10. The polarization dependent isolator of claim 1 having an insertion loss ≦0.5 dB.

11. The polarization dependent isolator of claim 1 having an isolation ≧40 dB.

12. The polarization dependent isolator of claim 11, which provides isolation at a nominal wavelength in a range from 800 to 1900 nm.

13. The polarization dependent isolator of claim 11, which provides isolation at a nominal wavelength of 1310 nm.

14. The polarization dependent isolator of claim 11, which provides isolation at a nominal wavelength of 1550 nm.

15. The polarization dependent isolator of claim 1, wherein the Faraday element is made of a magneto-optical material.

16. The polarization dependent isolator of claim 1, wherein the input polarizer is a wire grid polarizer.

17. The polarization dependent isolator of claim 1, wherein the input polarizer is a dichroic polarizer.

18. The polarization dependent isolator of claim 1, further comprising a lens disposed between the Faraday element and the single polarization fiber to focus the output beam emerging from the Faraday element into the single polarization fiber.

19. A polarization dependent isolator comprising:
a first isolator unit;
a second isolator unit cascaded in series with the first isolator unit; and
a single polarization fiber positioned adjacent the second isolator unit to receive a beam emerging from the second isolator unit.
wherein each of the isolator units comprises an input polarizer positioned at an input end of a Faraday element to polarize an input beam entering the input end of the Faraday element.

20. The polarization dependent isolator of claim 19, wherein the first isolator unit further comprises an output polarizer positioned at an output end of the Faraday element, the output polarizer in opposing relation to the input polarizer in the second isolator unit and having a polarization axis aligned with a polarization axis of the input polarizer in the second isolator unit.

21. A laser module, comprising:
a laser diode;
a Faraday element positioned adjacent the laser diode;
an input polarizer positioned at an input end of the Faraday element nearest to the laser diode to polarize light passing from the laser diode to the input end of the Faraday element; and
a single polarization fiber positioned at an output end of the Faraday element furthest from the laser diode to receive light emerging from the output end of the Faraday element, wherein the single polarization fiber also serves as coupling output fiber for the laser module.

22. The laser module of claim 21, further comprising a lens disposed between the laser diode and the input polarizer to couple light from the laser diode to the input polarizer.

23. The laser module of claim 21, further comprising a lens disposed between the Faraday element and the single polarization fiber to couple light from the Faraday element into the single polarization fiber.

24. The laser module of claim 21, wherein the polarization axis of the single polarization fiber is at 45° relative to the polarization axis of the input polarizer.

25. The laser module of claim 24, wherein the Faraday element rotates a polarization plane of a beam passing through the Faraday element by approximately 45°.
